(19) United States
(12) Patent Application Publication
(10) Pub. No.: US 2015/0280339 A1
(43) Pub. Date: Oct. 1, 2015

(54) CONNECTOR TERMINAL AND MATERIAL FOR CONNECTOR TERMINAL

(71) Applicants: AutoNetworks Technologies, Ltd., Yokkaichi-shi, Mie (JP); Sumitomo Wiring Systems, Ltd., Yokkaichi-shi, Mie (JP); SUMITOMO ELECTRIC INDUSTRIES, LTD., Osaka-shi, Osaka (JP)

(72) Inventors: Yoshifumi Saka, Yokkaichi-shi (JP); Masayuki Okubo, Yokkaichi-shi (JP); Hajime Watanabe, Yokkaichi-shi (JP)

(21) Appl. No.: 14/426,784

(22) PCT Filed: Jul. 22, 2013
(86) PCT No.: PCT/JP2013/069760

§ 371 Date: Mar. 9, 2015

(30) Foreign Application Priority Data
Sep. 21, 2012 (JP) 2012-208664

(51) Int. Cl. H01R 13/03; G01N 21/57

(52) U.S. Cl. CPC H01R 13/03; G01N 21/57; G01N 2201/12

(57) ABSTRACT

It is aimed to provide a connector terminal including a tin layer on an outermost surface and a material therefor which achieves a low insertion force without depending on the detail of the microstructure of the outermost surface and excessively increasing a contact resistance. A composite coating layer including areas where tin is exposed and areas where a copper-tin alloy is exposed on an outermost surface is formed on a surface of a base material in an area including a contact portion to be brought into contact with another electrically conductive member and the glossiness of the surface of the composite coating layer is in a range of 50 to 1000%.

### TECHNICAL FIELD

The present invention relates to a connector terminal and a material therefor and more particularly to a low-insertion force connector terminal and a material therefor.

### BACKGROUND ART

Copper or a copper alloy having good electrical conductivity is typically used for an electrically conductive member used in an electrical connection terminal or the like. Further, in recent years, aluminum and aluminum alloys have come to be used as materials for electrical connection terminals substituting for copper and copper alloys.

Since insulating films such as oxide films are formed on surfaces of copper and copper alloys or aluminum and aluminum alloys, a contact resistance at the time of contacting another conductor increases. Accordingly, a material in which a tin layer is formed after a base plating layer made of nickel or the like is formed on a surface of a base material made of copper, a copper alloy, aluminum, an aluminum alloy or the like if necessary has been conventionally generally used as a material for a connector terminal for automotive vehicle. Tin is characterized by being very soft as compared with other metals. In a tin-plated connector terminal, a relatively hard insulating tin oxide film is formed on a surface of a metal tin layer. However, since the tin oxide film is destroyed with a weak force and the soft tin layer is easily exposed, a good electrical contact is formed on the surface.

However, similarly due to the softness of tin, the tin-plated connector terminal has a problem of a high friction coefficient at the time of connecting the terminal. The tin layer is easily scraped off or tin easily adheres to itself when a connector contact point slides on the surface of the soft tin layer. This increases a friction coefficient on the surface of the tin layer, whereby a force necessary to insert the connector terminal (insertion force) increases.

Accordingly, an attempt has been made to reduce an insertion force of a tin-plated connector terminal by forming layers made of various metals below a tin plating layer. For example, patent literature 1 discloses a terminal in which a nickel plating layer, a copper plating layer, a tin plating layer are successively laminated on a surface of a base material made of a copper alloy and a copper-tin alloy is formed between the copper plating layer and the tin plating layer by a reflow process. Further, patent literature 2 discloses an electrical/electronic component using a plated material in which a base plating layer made of a group 4 to 10 metal, an intermediate plating layer formed of copper or a copper alloy and a surface plating layer formed of tin or a tin alloy are formed on an electrically conductive substrate made of copper or a copper alloy and a layer of an Sn—Cu intermetallic compound is formed between the intermediate plating layer and the surface plating layer by a subsequent heat treatment.

### CITATION LIST

### Patent Literatures

Patent Literature 1: Japanese Unexamined Patent Publication No. 2003-151668
Patent Literature 2: Japanese Unexamined Patent Publication No. 2007-204854

### SUMMARY OF THE INVENTION

### Problem the Invention Seeks to Solve

It is possible to reduce a friction coefficient of the outermost surface and, as a result, reduce a terminal insertion force by interposing various metal layers between the tin layer on the outermost surface and the base material surface. However, a friction phenomenon on the metal layer surface largely depends on the microstructure of the metal layer outermost surface such as fine unevenness. The microstructure of the outermost surface largely depends on a specific formation method and formation conditions and the like of each layer in the case of forming a material for terminal by laminating a plurality of metal layers by a technique such as plating. Further, even if each layer is formed by the same formation method and formation conditions, the microstructure of the outermost surface can vary to a certain degree among individual materials for terminal. Due to these factors, a friction coefficient of an outermost surface and an insertion force of an obtained terminal vary to a certain degree in many cases even among materials for terminal having a lamination structure of the same configuration. Further, not only the friction coefficient, but also a contact resistance is also an important parameter of a characteristic of a terminal contact portion. If the contact resistance excessively increases, it is not preferable for an electrical characteristic of the terminal. The contact resistance also largely depends on the microstructure of the outermost surface such as the kind and state of the metal exposed on the surface.

If the microstructure of the outermost surface of each material for connector terminal is confirmed in the manufacturing process of the connector terminal, it is possible to estimate a magnitude of an insertion force before the connector terminal is actually formed. However, to evaluate the microstructure of the metal layer surface, it is normally necessary to use a microscope such as an electron microscope or a probe microscope and such a device needs to be equipped. In addition, since it takes labor and cost to evaluate each individual material for connector terminal in such a way, this method is not realistic.

A problem sought to be solved by the present invention is to provide a connector terminal including a tin layer on an outermost surface and a material therefor which achieve a low insertion force without depending on the detail of the microstructure of the outermost surface and excessively increasing a contact resistance.

### Solution to Problem

To solve the above problem, a connector terminal according to the present invention is characterized in that a composite coating layer including areas where tin is exposed and areas where a copper-tin alloy is exposed on an outermost surface is formed on a surface of a base material in an area including a contact portion to be brought into contact with another electrically conductive member and the glossiness of the surface of the composite coating layer is in a range of 50 to 1000%.

Here, a thickness of the composite coating layer is preferably in a range of 0.5 to 5.0 μm.

Further, the glossiness of the surface of composite coating layer may be in a range of 100 to 800%.

Furthermore, the base material may be made of copper or a copper alloy or may be made of aluminum or an aluminum alloy.

An intermediate layer made of nickel is preferably formed between the base material and the composite coating layer, and a thickness of the intermediate layer may be 3 μm or smaller.

On the other hand, a material for connector terminal according to the present invention is characterized in that a composite coating layer including areas where tin is exposed and areas where a copper-tin alloy is exposed on an outermost surface is formed at least in a partial area of a surface of a base material and the glossiness of the surface of the composite coating layer is in a range of 50 to 1000%.

Here, the base material may be made of copper or a copper alloy or may be made of aluminum or an aluminum alloy.

An intermediate layer made of nickel is preferably formed between the base material and the composite coating layer.

### Effects of Invention

According to the connector terminal of the above invention, the very hard copper-tin alloy is exposed on the outermost surface. Thus, a friction coefficient on the outermost surface is reduced as compared to the case where only tin is exposed on the outermost surface. By having the glossiness in a predetermined range due to a correlation between the glossiness and the microstructure of the outermost surface, a low friction coefficient and a low insertion force are reliably realized regardless of the detail of the microstructure. Simultaneously, a contact resistance does not excessively increase as compared with the case where only tin is exposed on the outermost surface. Further, the glossiness is a parameter enabling easy measurement and can easily guarantee a low insertion force for individual connector terminals.

Here, if the thickness of the composite coating layer is in the range of 0.5 to 5.0 μm, a low insertion force is more easily realized.

Further, if the glossiness of the composite coating layer is in the range of 100 to 800%, a particularly low insertion force is obtained.

Furthermore, if the base material is made of copper or a copper alloy or aluminum or an aluminum alloy, the connector terminal is excellent in electrical characteristics and mechanical characteristics.

If the intermediate layer made of nickel is further formed between the base material and the composite coating layer, high adhesion is obtained between the base material and the composite coating layer and the diffusion of base material metal into the composite coating layer is suppressed.

On the other hand, according to the material for connector terminal of the present invention, by having the glossiness in a predetermined range due to a correlation between the glossiness and the microstructure of the outermost surface, a low friction coefficient is guaranteed regardless of the detail of the microstructure. Thus, if this material is used as a material for connector terminal and the composite coating layer is arranged on the outermost surface of a terminal contact portion, a connector terminal having a low insertion force can be reliably obtained without acquiring knowledge on the microstructure of the outermost surface.

### BRIEF DESCRIPTION OF DRAWINGS

FIG. 1 are diagrams showing an example of the structure of a composite coating layer, wherein FIG. 1(a) is a perspective view and FIG. 1(b) is an enlarged section,

FIG. 2 is a diagram showing the configuration of a connector terminal according to one embodiment of the present invention, i.e. a section of the entire connector terminal and an enlarged perspective view of a contact portion,

FIG. 3 is an SEM image of a surface of a material for connector terminal according to an example of the present invention, and

FIG. 4 is a graph showing a relationship between an alloy exposure amount and glossiness in the material for connector terminal according to the example of the present invention.

### EMBODIMENT OF INVENTION

Hereinafter, an embodiment of the present embodiment is described in detail using the drawings.

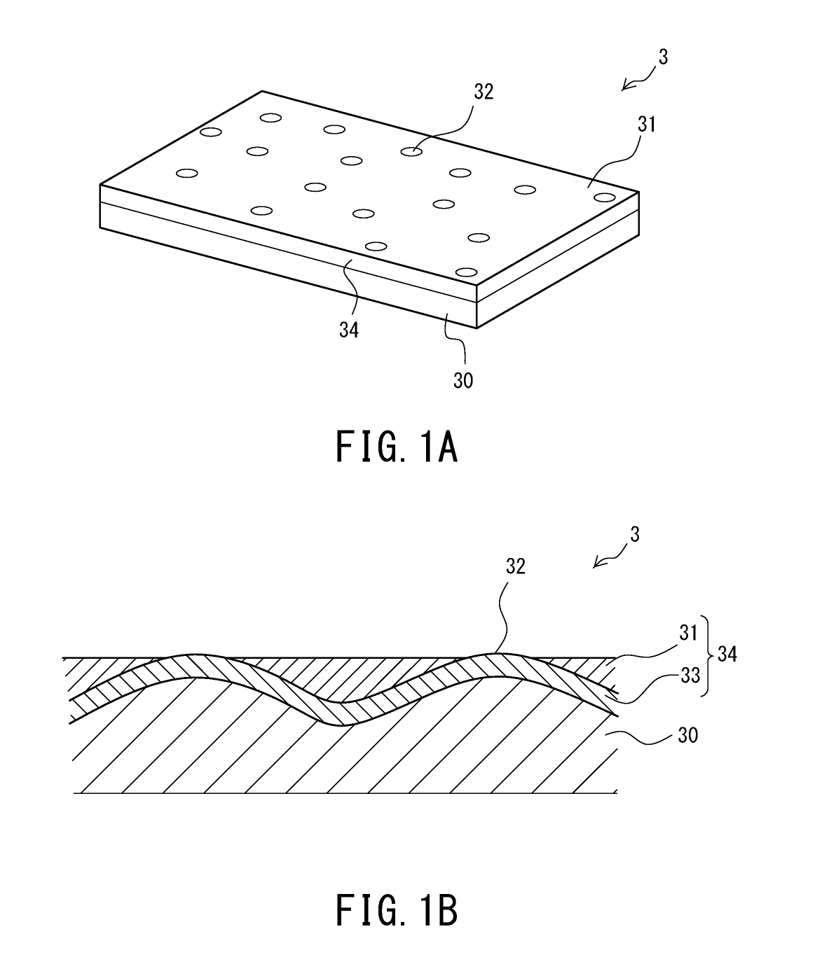

An example of a material for connector terminal (hereinafter, merely referred to as a material for terminal in some cases) according to the present invention is diagrammatically shown in FIG. 1(a). A material for connector terminal 3 is such that a composite coating layer 34 is formed on a base material 30. Areas where a tin layer 31 is exposed and alloy exposed parts 32 where a copper-tin alloy is exposed are mixedly present on an outermost surface of the composite coating layer 34.

Glossiness measured for the surface of the composite coating layer 34 where the tin layer 31 and the alloy exposed parts 32 are mixedly present is in a range of 50 to 1000%. Here, glossiness is based on mirror surface glossiness at an angle of incidence θ specified on a glass surface having a refractive index of 1.57 in accordance with JIS Z 8741-1997 and expressed with this value indexed as 100%. Here, measurement is conducted at a measurement angle (angle of incidence) θ=20°. Note that the glossiness of a pure tin layer surface heated in a reflow furnace is about 1500 to 1600%.

On the outermost surface of the composite coating layer 34, the tin layer 31 is exposed. Since tin has a low resistivity and is soft and destroyed only by applying a small load to an oxide film formed on a surface, a low contact resistance is given by coating the outermost surface of a contact portion to be brought into contact with another electrically conductive member in the connector terminal with tin. However, due to the softness thereof, tin is easily scraped off and adheres to itself. If only the tin layer is exposed on the entire surface, a friction coefficient on the surface increases and an insertion force of the terminal increases. However, since the very hard copper-tin alloy is exposed in the form of the alloy exposed parts 32 on the outermost surface in this material for connector terminal 3, scraping off on the surface and adhesion are unlikely to occur and a low friction coefficient is exhibited unlike a layer made only of soft metal such as tin. In this material for connector terminal 3, a low contact resistance is obtained and a low insertion force is achieved at the time of forming a terminal since the tin layer 31 and the alloy exposed parts 32 are exposed on the outermost surface.

The material for terminal 3 can achieve a low insertion force required at the time of forming a terminal by having glossiness of 1000% or lower. This is thought to be because glossiness has a strong correlation with an area of the alloy exposed parts 32 occupying on the entire outermost surface (alloy exposure amount) as described in examples later and the glossiness of the surface increases as the alloy exposure amount increases. That is, since the glossiness of the surface of the copper-tin alloy is lower than that of the surface of tin, the glossiness of the entire surface is reduced and a total area of the alloy exposed parts 32 with respect to the surface area of the tin layer 31 increases as a ratio of the alloy exposed areas 32 made of the copper-tin alloy increases, whereby an effect of reducing the insertion force by the exposure of the hard copper-tin alloy on the outermost surface is thought to be obtained.

On the other hand, since a contact resistance on the surface of the copper-tin alloy is larger than that of tin, a contact resistance of a terminal contact portion becomes excessively large if the total area of the alloy exposed parts 32 is too large. In this material for terminal 3, by setting the glossiness at 50% or higher, the area occupied by the alloy exposed parts 32 does not become excessively large and an excessive increase of the contact resistance is avoided as compared with the case where only tin is exposed on the outermost surface without including the alloy exposed parts.

In terms of a balance between the insertion force at the time of forming the terminal and the contact resistance, the glossiness of the surface of the material for terminal 3 is more preferably in a range of 100 to 800% and even more preferably in a range of 130 to 550%.

In the present invention, a material for terminal capable of realizing required low insertion force and low contact resistance is obtained not by directly measuring a microscopic parameter called the total area of the alloy exposed parts 32, but by measuring and controlling a macroscopic parameter called the glossiness of the surface. To evaluate the total area of the alloy exposed parts 32, the surface of the composite coating layer 34 needs to be observed using a microscope device such as an electron microscope, a laser microscope or a probe microscope. On the other hand, since the glossiness of the surface can be measured only by irradiating light from a light source and measuring an intensity of the light reflected by a mirror surface, that value can be very easily known. Thus, the material for terminal having a terminal insertion force and a contact resistance reduced to desired ranges can be easily formed by specifying the configuration of the outermost surfaces of the alloy exposed parts 32 using the glossiness of the surface as a parameter. Since a glossiness measuring device can also be installed at an intermediate position of a terminal manufacturing line, it is possible to measure glossiness for all individual manufactured terminals and effectively eliminate variations of the terminal insertion force and the contact resistance derived from a variation of the surface structure of the composite coating layer 34 caused by variations of manufacturing conditions for the material for terminal and the like.

A thickness of the composite coating layer 34 is preferably in a range of 0.5 to 5.0 μm. If the composite coating layer 34 is thinner than this range, a thickness of the copper-tin alloy from the alloy exposed parts 32 in a depth direction also becomes smaller. Thus, the effect of reducing the insertion force at the time of forming the terminal cannot be sufficiently obtained. Further, since the tin layer 31 becomes thinner, the effect of reducing the contact resistance on the surface is also not sufficiently obtained. Further, if the composite coating layer 34 is thicker than the above range, a total amount of the hard copper-tin alloy increases and the productivity and processability of the terminal are reduced.

The copper-tin alloy forming the alloy exposed parts 32 of the composite coating layer 34 may have any composition ratio of copper and tin. This is because an intermetallic compound of copper and tin generally has higher hardness than tin. However, a layer mainly containing an intermetallic component Cu₆Sn₅ having high hardness and formed only by laminating and heating copper and tin is particularly preferable. Cu₆Sn₅ is preferable also in the sense of having not only hardness, but also excellent oxidation resistance and corrosion resistance.

As described above, the glossiness of the composite coating layer 34 is correlated with the alloy exposure amount, i.e. the total area of the alloy exposed parts 32. However, without depending on the shape, size and density of the alloy exposed parts 32, substantially the same glossiness is thought to be given if the total area of the alloy exposed parts is the same. Thus, the sizes, shapes and a distribution density of the individual alloy exposed parts 32 are not particularly specified. However, in order to enjoy both the effect of reducing the insertion force by the alloy exposed parts 32 and the effect of reducing the contact resistance by the exposed parts of the tin layer 31 in the terminal contact portion in forming the connector terminal, the sizes, shapes and distribution density of the alloy exposed parts 32 are preferably specified to include both of the alloy exposed part 32 and the exposed part of the tin layer 31 on the outermost surface of the contact portion.

An average interval of the alloy exposed parts 32 is desirably 0.5 mm or smaller at least in one direction. This is because it becomes difficult to include both the alloy exposed part 32 and the exposed part of the tin layer 31 in a contact portion of a general connector terminal if the interval is larger than this.

Further, if a height difference between the alloy exposed parts 32 and the exposed parts of the tin layer 31 is too large, it becomes difficult for both the alloy exposed part 32 and the exposed part of the tin layer 31 to come into contact with a mating electrically conductive member in the terminal contact portion and both effects of the low insertion force and the low contact resistance are unlikely to be simultaneously enjoyed. From this point of view, the surface of the composite coating layer 34 preferably has an average arithmetic roughness of 0.15 μm at least in one direction and 3.0 μm or less in all directions.

The base material 30 on the surface of which the composite coating layer 34 is formed may be any material if it can serve as a base material for forming the contact terminal and can be selected according to an intended use. Copper or a copper alloy or aluminum or an aluminum alloy can be illustrated as such. For example, if a wire to be connected to the connector terminal is made of copper or a copper alloy, copper or a copper alloy may be selected as the base material 30. If the wire is made of aluminum or an aluminum alloy, aluminum or an aluminum alloy may be selected as the base material 30. By using the same kind of metals as the wire material and the material of the base material 30 constituting the connector terminal, corrosion at joint portions thereof is prevented and electrical characteristics are maintained even if the wire and the connector terminal are used under a corrosive environment. Note that wires made of aluminum or an aluminum alloy have been used in recent years particularly in the field of automotive wiring due to a demand to make electrical wiring lighter and the like, and the importance of excellent connector terminals using aluminum or an aluminum alloy as a base material has been increased.

An intermediate layer made of nickel may be formed between the base material 30 and the composite coating layer 34. By forming the intermediate terminal made of nickel, the diffusion of metal atoms from the base material 30 into the composite coating layer 34 can be hindered. This prevents the metal atoms in the base material 30 from being diffused from the base material 30 into the tin layer 35 and oxidized on a surface to increase the contact resistance when the connector terminal is used in a high-temperature environment or when heat is generated due to power application. Further, this intermediate terminal also functions to increase adhesion between the base material 30 and the composite coating layer 34. If the base material 30 is made of copper or a copper alloy, the former diffusion preventing effect is important. If the base material 30 is made of aluminum or an aluminum alloy, the latter adhesion improving effect is important. A thickness of the intermediate terminal is preferably not larger than 3.0 μm. If the terminal is thicker than this, the processability of the connector terminal is deteriorated due to the hardness of the nickel layer.

It does not matter how the composite coating layer 34 in which both the alloy exposed parts 32 and the tin layer 31 are exposed on the outermost surface is configured if predetermined glossiness can be given. For example, a structure which is formed by spraying fine particles made of a copper-tin alloy before or during the tin layer 31 is formed and in which the fine particles are embedded in the tin layer 31 in a partly exposed state can be illustrated. Alternatively, a structure in which an uneven structure is formed on a surface of the base material 30, a copper-tin alloy layer is formed on a base material surface with the uneven structure reflected thereon and the tin layer 31 is so formed that the vicinities of the tops of projections of the copper-tin alloy layer remain exposed can be illustrated. The latter structure is more preferable in terms of manufacturing easiness and the controllability of the alloy exposure amount.

An example of the latter structure is shown in FIG. 1(b). The material for connector terminal 3 is such that a copper-tin alloy layer 33 is laminated on a surface of a base material 30 made of copper or a copper alloy or aluminum or an aluminum alloy and having an uneven structure formed on the surface. The copper-tin alloy layer 33 has a uniform thickness in a range not larger than a height difference of the uneven structure on the surface of the base material 30 and the uneven structure formed on the surface of the base material 30 is reflected on a surface of the copper-tin alloy layer 33, whereby an uneven structure is formed on the surface of the copper-tin alloy layer 33.

A tin layer 31 having a smooth surface is formed on the copper-tin alloy layer 33. A thickness of the tin layer 31 is set to be smaller than a height difference on the surface of the copper-tin alloy layer 33 even at the position of a maximum thickness. This causes parts of the copper-tin alloy layer 33 including the tops of the projections to be exposed without being coated by the tin layer 31, whereby alloy exposed parts 32 are formed. A coating layer made of an assembly of the copper-tin alloy layer 33 and the tin layer 31 and including the alloy exposed parts 32 becomes a composite coating layer 34. An intermediate layer made of nickel may be formed at an interface between the composite coating layer 34 and the base material 30, i.e. at an interface between the copper-tin alloy layer 33 and the base material 30.

A thickness of the copper-tin alloy layer 33 is preferably in a range of 0.1 to 3.0 μm. If the copper-tin alloy layer 33 is thinner than this, an effect of reducing a friction coefficient is unlikely to be sufficiently exhibited. Further, if the copper-tin alloy layer 33 is thicker than this, the productivity and processability of the terminal are deteriorated.

An average value of the thickness of the tin layer 31 is desirably in a range of 0.2 to 5.0 μm and the thickness of the tin layer 31 is desirably in a range of 1.2 to 20 μm even at the position of a maximum thickness, i.e. at the position of a recess of the copper-tin alloy layer 33. If the tin layer 31 is thinner than this range, the contact resistance on the outermost surface becomes excessively large. If the tin layer 31 is thicker than this range, the friction coefficient increases and the effect of reducing the friction coefficient by the formation of the alloy exposed parts 32 is canceled out.

The material for connector terminal 3 configured as just described may be formed by any method. For example, the uneven structure of the base material 30 can be formed by a sand blast method or the like. A nickel layer may be formed on that uneven structure by electrolytic plating if necessary and a copper layer and a tin layer may be laminated in this order on the surface of the nickel layer. Thereafter, the copper-tin alloy layer 33 may be formed and the surface of the tin layer 31 may be smoothened by performing a reflow process.

Since the formation of the copper-tin alloy layer 33 and the smoothening of the tin layer 31 can be simultaneously performed according to this method, the composite coating layer 34 can be easily formed. Further, the copper-tin alloy layer 33 having substantially the composition of Cu₆Sn₅ can be formed.

Note that since a hard and thick oxide film is formed on the surface if the substrate 30 is made of aluminum or an aluminum alloy, it is difficult to form a nickel layer or a copper layer directly on that surface by electrolytic plating. In this case, the nickel layer or the copper layer may be formed by electrolytic plating after a metal layer of zinc or the like is deposited on the surface of the substrate 30 by electroless plating if necessary.

The glossiness can be adjusted by adjusting the total area of the alloy exposed parts 32. Specifically, this adjustment can be made by controlling conditions in forming the uneven structure on the surface of the base material 30 by the sand blast method or the like to change the density and/or size of the projections or by controlling the thickness of the tin layer 31 to be formed to adjust the heights of the projections of the copper-tin alloy layer 33 to be embedded in the tin layer. The latter method is more preferable in terms of control accuracy and easiness. However, in this case, the thickness of the tin layer 31 to be formed needs to be set such that a height difference between the alloy exposed parts 32 and the surface of the tin layer 31 is in such a range that both the alloy exposed part 32 and the exposed part of the tin layer 31 can come into contact with the mating electrically conductive member in forming the terminal contact portion.

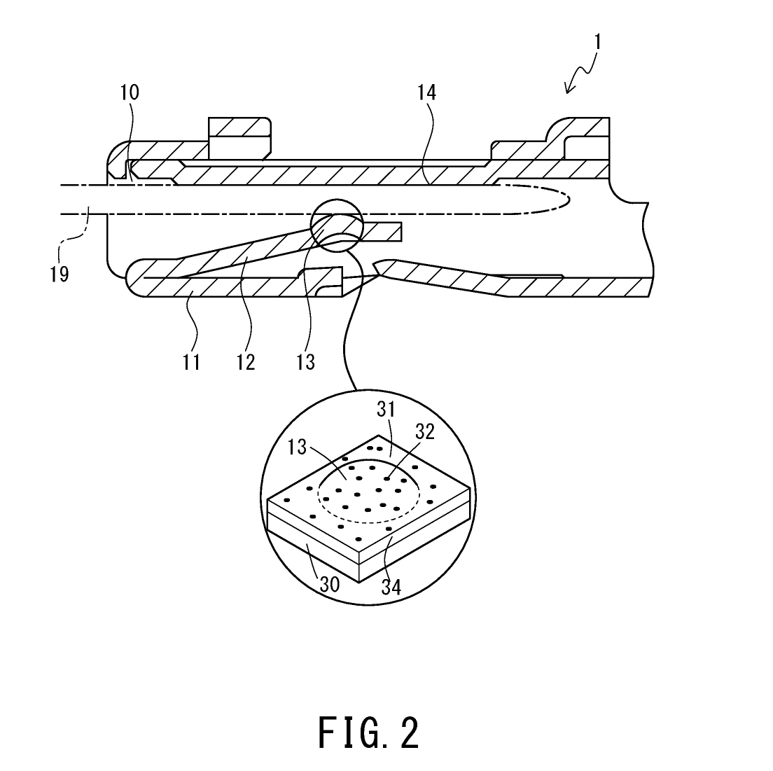

The connector terminal according to the present invention may have any shape. As an example, the configuration of a female connector terminal 1 is shown in FIG. 2. The female connector terminal 1 is shaped similarly to known female connector terminals. Specifically, a pressing portion 10 of the female connector terminal 1 is formed into a rectangular tube with an open front side and a male terminal 19 is inserted into the pressing portion 10. A resilient contact piece 12 folded toward an inner rear side is formed at an inner side of a bottom surface plate 11 of the female plated terminal 1. The resilient contact piece 12 applies an upward force to the male terminal 19. A surface of a ceiling plate facing the resilient contact piece 12 serves as an inner facing contact surface 14. The male terminal 19 is pressed and held between the resilient contact piece 12 and the inner facing contact surface 14 by being pressed against the inner facing contact surface 14 by the resilient contact piece 12.

A part of the resilient contact piece 12 to be held in contact with the male terminal 19 is formed with an embossed portion 13. The embossed portion 13 is held in contact with the male terminal 19 at a position including the top thereof

The composite coating layer 34 composed of the tin layer 31 and the alloy exposed parts 32 is formed in an area of the female connector terminal 1 at least including the top of the embossed portion 13 as shown in an enlarged perspective view in FIG. 2. The composite coating layer 34 may be formed in a larger range or may be formed on the entire surface of the female connector terminal 1. Further, the composite coating layer 34 may be formed also on a surface of the male terminal 19.

### EXAMPLES

The present invention is described in detail using examples.

### Examples

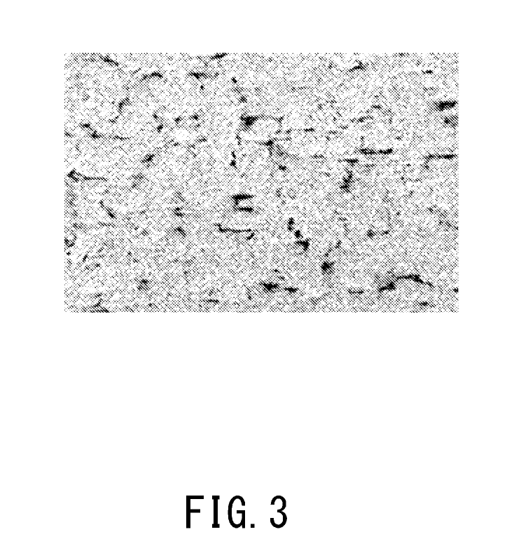

A plated member was prepared in which a nickel layer having an average thickness of 0.3 μm was formed on a copper alloy base material having an uneven structure, a copper-tin alloy layer was formed on the nickel layer, and a tin layer with a smoothened surface was formed on the copper-tin alloy layer. A scanning electron microscope (SEM) image of a surface of this plated member is shown in FIG. 3. A shortest interval between positions where alloy exposed parts observed to be dark were formed was 5 μm and a longest interval was 97 μm. A plurality of plated members having different areas of the alloy exposed parts of the copper-tin alloy layer were prepared by making thicknesses of tin layers different. Here, an average value of the thickness of the tin layer was in a range of 0.6 μm to 1.2 μm. Note that a case where an average value of the thickness of the tin layer was 0.9 μm (average glossiness: 440%) is shown as an SEM image in FIG. 3.

After this plated member was punched out into a development shape of a terminal, bending was applied to form a female connector terminal shaped as shown in FIG. 2. A long diameter of a contact portion evaluated by the SEM was 150 μm.

### Comparative Example

A plated member used for ordinary tin-plated connector terminals in which a tin layer having a thickness of 1 μm was formed on a copper alloy base material was prepared and a female connector terminal shaped similarly to the examples was formed.

[Test Method]

### (Evaluation of Glossiness and Alloy Exposure Amount)

Glossiness was measured at a measurement angle (θ) of 20° for the plated members according to each example and the comparative example in accordance with JIS Z 8741-1997, using UGV-6P produced by Suga Test Instruments Co., Ltd. as a measuring machine.

Further, SEM observation was conducted for the plated member according to each example and the total of the areas of the alloy exposed parts observed to be dark in an SEM image as shown in FIG. 3 was calculated. A ratio of this total area of the alloy exposed parts to the entire surface area of the plated member was defined as an alloy exposure amount. Here, if the alloy exposed parts have a certain height, the area thereof is specified as an area obtained by projecting the plated member on a macroscopic surface.

(Evaluation of Friction Coefficient)

A dynamic friction coefficient was evaluated as an index of a terminal insertion force for the plated members according to each example and the comparative example. That is, the plated member in the form of a flat plate and an embossed plated member having a radius of 1 mm were held in contact in a vertical direction, and a (dynamic) friction force was measured using a load cell by pulling the embossed plated member at a speed of 10 mm/min in a horizontal direction while applying a load of 3 N in the vertical direction using a piezo actuator. A value obtained by dividing the friction force by the load was set as a friction coefficient.

(Evaluation of Terminal Insertion Force)

An insertion force was measured by the following method for the terminals according to the examples and the comparative example. That is, using a MODEL-1605N type precision load tester produced by Aikoh Engineering Co., Ltd., a female terminal was fixed with a connection opening faced up, a male terminal attached to a load cell was moved downwardly at a head speed of 10 mm/min from above the female terminal so that an inserting direction was a downward direction, and a load cell load change was measured until insertion was completed.

(Evaluation of Contact Resistance)

A contact resistance was measured by a four-terminal method for the plated members according to each example and the comparative example. At this time, an open voltage was set at 20 mV, an energizing current was set at 10 mA and a load of 0 to 40 N was applied in an increasing direction and a decreasing direction. One electrode was in the form of a flat plate and the other was in the form of an emboss having a radius of 1 mm. As a representative, a contact resistance value measured at a load of 10 N in a direction to increase the load was compared for each plated member.

[Test Result and Consideration]

(Evaluation of Terminal Insertion Force)

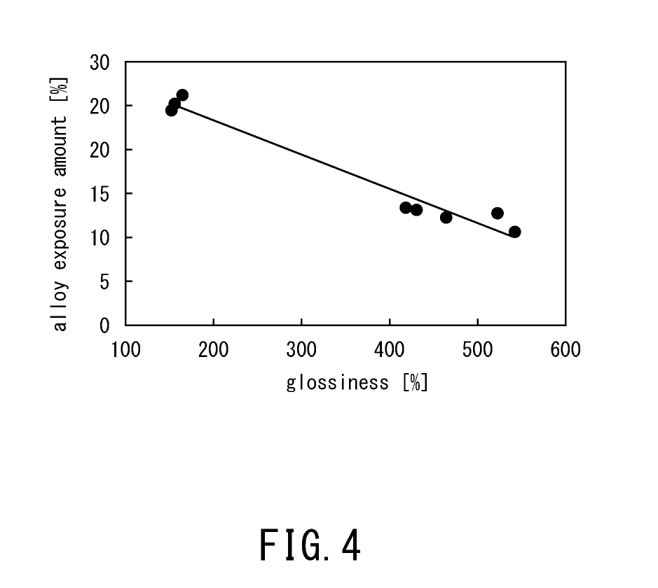

FIG. 4 shows a relationship between the alloy exposure amount and the glossiness. Looking at this, plot points are well approximated by a straight line as shown by a thin line. That is, a good linear correlation relationship exists between the alloy exposure amount and the glossiness. The higher the glossiness, the smaller the alloy exposure amount. This is interpreted to be because the copper-tin alloy has lower glossiness than tin and the glossiness of the entire surface is proportionally reduced as the area occupied by the copper-tin alloy increases.

Next, a measurement result on the friction coefficient, insertion force and contact resistance at a load of 10 N is shown in TABLE 1 below together with the tin plating thickness (average value), glossiness and alloy exposure amount for the plated members according to the examples that give three kinds of glossiness and the plated member according to the comparative example.

TABLE 1

| | | | | C-Exa. |
|---|---|---|---|---|
| | Exa. 1 | Exa. 2 | Exa. 3 | (pure Sn) |
| Tin plating thickness [μm] | 0.6 | 0.9 | 1.2 | 1 |
| Alloy exposure amount [%] | 25 | 13 | 12 | 0 |
| Glossiness [%] | 160 | 440 | 530 | 1370 |
| Friction coefficient | 0.19 | 0.21 | 0.23 | 0.35 |
| Insertion force [N] | 0.8 | 1.0 | 2.2 | 2.5 |
| Contact resistance [mΩ] | 0.4 | 0.4 | 0.4 | 0.4 |

According to TABLE 1, any of the plated members according to the examples exhibits a low friction coefficient and a low insertion force as compared with the plated member formed only with the tin layer. That is, reductions of the friction coefficient and the insertion force are achieved as compared with the case where only the tin layer is exposed by exposing the tin layer and the copper-tin alloy on the terminal contact portion and having glossiness in the range of 130 to 1000%. Also for the contact resistance, a value equivalent to that of the pure tin plated member of the comparative example is obtained for the plated member according to each example in which the copper-tin alloy is exposed.

Further, in each example, the friction coefficient and the insertion force appear to tend to decrease as the glossiness decreases. This is thought to be because the glossiness of the entire surface decreases and the friction coefficient of the surface is reduced and the terminal insertion force is reduced by an effect brought about by the hardness of the exposed copper-tin alloy as the alloy exposure amount increases.

Although the embodiment of the present invention has been described in detail above, the present invention is not limited to the above embodiment at all and various modifications can be made without departing from the gist of the present invention.

Note that although the alloy exposed as the alloy exposed parts together with the tin layer on the outermost surface is the copper-tin alloy in the present embodiment, there is no limitation to the copper-tin alloy if the alloy is harder than tin. A similar concept can be applied also when another kind of alloy forms alloy exposed parts. That is, although the range of required glossiness is possibly different from that in the case of the copper-tin alloy (50 to 1000%), the glossiness of the entire surface can similarly indicate a low insertion force as a parameter. A nickel-tin alloy can be illustrated as such another kind of alloy. More specifically, a configuration can be illustrated in which a composite coating layer having alloy exposed parts made of a nickel-tin alloy and a tin layer exposed on an outermost surface is formed on a surface of a base material made of aluminum or an aluminum alloy via a nickel intermediate layer.

1. A connector terminal, characterized in that a composite coating layer including areas where tin is exposed and areas where a copper-tin alloy is exposed on an outermost surface is formed on a surface of a base material in an area including a contact portion to be brought into contact with another electrically conductive member and the glossiness of the surface of the composite coating layer is in a range of 50 to 1000%.

2. The connector terminal of claim 1, wherein a thickness of the composite coating layer is in a range of 0.5 to 5.0 μm.

3. The connector terminal of claim 1, wherein the glossiness of the surface of composite coating layer is in a range of 100 to 800%.

4. The connector terminal of claim 1, wherein the base material is made of copper or a copper alloy.

5. The connector terminal of claim 1, wherein the base material is made of aluminum or an aluminum alloy.

6. The connector terminal of claim 1, wherein an intermediate layer made of nickel is formed between the base material and the composite coating layer.

7. The connector terminal of claim 6, wherein a thickness of the intermediate layer is 3 μm or smaller.

8. The connector terminal of claim 1, wherein an average arithmetic roughness of the surface of the composite coating layer is 0.15 μm or less in one direction and 3.0 μm or less in all directions.

9. A material for connector terminal, characterized in that a composite coating layer including areas where tin is exposed and areas where a copper-tin alloy is exposed on an outermost surface is formed at least in a partial area of a surface of a base material and the glossiness of the surface of the composite coating layer is in a range of 50 to 1000%.

10. The material for connector terminal of claim 9, wherein the base material is made of copper or a copper alloy.

11. The material for connector terminal of claim 9, wherein the base material is made of aluminum or an aluminum alloy.

12. The material for connector terminal of claim 11, wherein an intermediate layer made of nickel is formed between the base material and the composite coating layer.

13. The material for connector terminal of claim 9, wherein an average arithmetic roughness of the surface of the composite coating layer is 0.15 μm or less in one direction and 3.0 μm or less in all directions.

14. A method for manufacturing a connector terminal made of a terminal material with a composite coating layer including areas where tin is exposed and areas where a copper-tin alloy is exposed on an outermost surface and formed on a surface of a base material in an area including a contact portion to be brought into contact with another electrically conductive member, comprising:
a first step of estimating a relationship between an alloy exposure amount and the glossiness of the surface of the composite coating layer using a plurality of test samples having different alloy exposure amounts which are ratios of an area occupied by the copper-tin alloy to the entire surface of the composite coating layer; and
a second step of measuring the glossiness of the surface of the composite coating layer for the terminal material different from the test samples and specifying the alloy exposure amount of the terminal material by a value of the measured glossiness based on the relationship of the alloy exposure amount and the glossiness estimated in the first step.

15. A method for manufacturing a material for connector terminal with a composite coating layer including areas where tin is exposed and areas where a copper-tin alloy is exposed on an outermost surface and formed in a partial area of a surface of a base material, comprising:
a first step of estimating a relationship between an alloy exposure amount and the glossiness of the surface of the composite coating layer using a plurality of test samples having different alloy exposure amounts which are ratios of an area occupied by the copper-tin alloy to the entire surface of the composite coating layer; and
a second step of measuring the glossiness of the surface of the composite coating layer for the material for connector terminal different from the test samples and specifying the alloy exposure amount of the material for connector terminal by a value of the measured glossiness based on the relationship of the alloy exposure amount and the glossiness estimated in the first step.

16. The material for connector terminal of claim 10, wherein an intermediate layer made of nickel is formed between the base material and the composite coating layer.
